(19) United States
(12) Patent Application Publication
(10) Pub. No.: US 2010/0293357 A1
(43) Pub. Date: Nov. 18, 2010

(54) Method and apparatus for providing platform independent secure domain

(76) Inventors: Jae-chul Park, Seoul (KR); Heon-soo Lee, Seoul (KR); Dong-jin Park, Seoul (KR)

Correspondence Address: LEE & MORSE, P.C., 3141 FAIRVIEW PARK DRIVE, SUITE 500, FALLS CHURCH, VA, 22042, US

(21) Appl. No.: 12/662,480

(22) Filed: Apr. 20, 2010

(30) Foreign Application Priority Data
May 18, 2009 (KR) 10-2009-0043095

(51) Int. Cl. G06F 9/38; G06F 9/312; G06F 12/00

(52) U.S. Cl. 712/205; 711/102; 712/234; 711/E12.001; 712/E09.06; 712/E09.056; 712/E09.033

(57) ABSTRACT

A platform independent secure domain providing apparatus, which determines whether an execution environment is to be in a secure domain and a non-secure domain by a secure bit. The apparatus includes a secure monitor that is adapted to generate a branch instruction when a call to a secure code is sensed, turn on the secure bit when the branch instruction has been successfully executed, and turn off the secure bit when the execution of the secure code is finished, an instruction bypass read only memory (ROM) adapted to receive the branch instruction from the secure monitor, and a processor adapted to execute the branch instruction that is fetched from the instruction bypass ROM.

### BACKGROUND

1. Field

Embodiments relate to methods and apparatus for providing a platform independent secure domain. More particularly, embodiments relate to a method and apparatus for providing a platform independent secure domain that is adapted to convert an execution environment between a secure domain and a non-secure domain based on whether a secure bit is turned on when a randomly generated branch instruction is successfully executed.

2. Description of the Related Art

As applications executed on mobile devices such as mobile phones or PDAs increasingly process sensitive data related to security, e.g., an encryption key, a certificate, an international mobile equipment identity (IMEI), an SIMLock, etc., the types and/or degree of attacks that threaten the security of the mobile devices are also increasing.

In general, software of a mobile device including a processor is classified as an application and an operating system (OS). The OS usually controls system resources or schedules execution of the applications, thereby connecting the application to hardware and managing the whole system. Thus, the OS generally plays a significant role in the operation of a mobile device.

To protect the operations of the OS, the processor generally provides a privileged mode for the OS that is different from a user program mode.

However, even if an OS kernel is protected in the OS privileged system, if there is a security flaw in the OS, the OS kernel is useless. General-purpose OSs, which are typically used, have many security flaws. However, strict security-policy is generally not applied between applications because of convenience in usage. Accordingly, the security of data used in such applications executed in general-purpose OSs is hard to guarantee.

In order to improve data security, a general-purpose OS designed to be secure needs to be used or security-related data may be separately executed in an independent execution environment. The first method, which applies an exclusive OS to a general-purpose device, is not appropriate in terms of costs and convenience in usage.

The second method of separately executing security-related data in an independent execution environment may be effective in that existing OSs and existing applications are used. However, the functions of the OS need to be modified, a predetermined processor core needs to be used, or it is difficult to design a circuit for analyzing a software sequence pattern, which is time consuming.

Accordingly, there is increasingly a need for a method and apparatus for providing data security that, e.g., can be applied to various general-purpose platforms irrespective of the type of processor or structure of a bus, minimize time for developing a system on chip (SoC) for minimizing modification of an OS, and minimize an independent security environment in which security-related data is treated.

### SUMMARY

Embodiments are therefore directed to methods and apparatus for a providing platform independent secure domain, which substantially overcome one or more of the problems due to the limitations and disadvantages of the related art.

It is therefore a feature of an embodiment to provide a method of converting between a secure domain and a non-secure domain is not reliant on the type of processor, the type of operating system, or the structure of a bus, and thus may be applied to general-purpose operating systems or general-purpose platforms irrespective of a platform, thereby reducing the time for designing a system on chip (SoC).

It is therefore a separate feature of an embodiment to provide a platform independent secure domain that is adapted to be converted between a secure domain and a non-secure domain irrespective of the type of processor, the type of operating system, or the structure of a bus, and thus may be applied to general-purpose operating systems or general-purpose platforms irrespective of a platform, thereby reducing the time for designing a system on chip (SoC).

It is therefore a separate feature of an embodiment to provide a secure domain that is not reliant on the type of processor, the type of operating system, or the structure of a bus, and thus may be applied to general-purpose operating systems or general-purpose platforms irrespective of a platform, thereby reducing the time for designing a system on chip (SoC).

It is therefore a separate feature of an embodiment to provide a platform independent secure domain providing apparatus in which a function of a processor is not modified, and thus an operating system may be quickly developed and inspected.

At least one of the above and other features and advantages may be realized by providing a platform independent secure domain providing apparatus, which determines whether an execution environment is to be in a secure domain and a non-secure domain by a secure bit, the apparatus including a secure monitor that is adapted to generate a branch instruction when a call to a secure code is sensed, turn on the secure bit when the branch instruction has been successfully executed, and turn off the secure bit when the execution of the secure code is finished, an instruction bypass read only memory (ROM) adapted to receive the branch instruction from the secure monitor, and a processor adapted to execute the branch instruction that is fetched from the instruction bypass ROM.

The secure monitor may include a random number generator adapted to randomly generating a branch offset, and a monitor control unit adapted to generate the branch instruction by using the generated branch offset when the call to the secure code is sensed.

The secure monitor may be adapted to generate the branch instruction a predetermined number of times, and to turn on the secure bit when the processor has successfully fetched all of the generated branch instructions.

The secure monitor may include an address comparator to determine whether a predicted branch address generated by the secure monitor and a next branch address provided by a processor has the same value or not.

The secure monitor may include a special function register (SFR) bank that is adapted to store an execution set instruction for setting the secure domain, wherein the execution set instruction is provided to the instruction bypass ROM from the SFR bank, and is sequentially fetched by the processor after the secure bit is turned on.

The secure monitor may provide the secure bit to an address decoder and/or an access restrictor, and the address decoder or the access restrictor is adapted to control access of the processor to a secure area related to the secure code, based on the secure bit.

When the secure bit is turned off, the execution environment may be converted from the secure domain to the non-secure domain, and when the secure bit is turned on, the execution environment may be converted from the non-secure domain to the secure domain.

The secure monitor may be arranged away from the processor.

The secure monitor may be mounted on the processor.

The instruction bypass ROM may be arranged away from the processor.

The instruction bypass ROM may be mounted on the processor.

The instruction bypass ROM may be a hardwired ROM.

The instruction bypass ROM and the secure monitor may be connected to each other.

At least one of the above and other features and advantages may be separately realized by providing a method of providing a platform independent secure domain, wherein an execution environment is determined as a secure domain or a non-secure domain by a secure bit, the method including generating a branch instruction by monitoring a call to a secure code by a processor, providing the branch instruction to an instruction bypass ROM, fetching the branch instruction from the instruction bypass ROM and executing the branch instruction, wherein the branch instruction is executed by the processor, and turning on the secure bit when the branch instruction has been successfully executed by the processor.

The method may include providing the secure bit to an address decoder and/or an access restrictor, wherein the address decoder and/or the access restrictor control access of the processor to a secure area related to the secure code, based on the secure bit.

The method may include fetching an execution set instruction from the instruction bypass ROM after the secure bit is turned on, wherein the fetching of the execution setup instruction is performed by the processor, and setting the execution environment as a secure domain, wherein the setting of the execution environment is performed by the processor.

The branch instruction may be generated a predetermined number of times, and if all of the generated branch instructions are executed successfully by the processor, the secure bit may be generated.

It may be determined if all the generated branch instructions are executed successfully by calculating, in advance, an estimated branch address using a random branch offset, and comparing a branch address transferred by the processor while performing the branch instruction with the estimated branch instruction.

The method may include executing the secure code after the secure bit is turned on, wherein the secure code may be executed by the processor, and turning off the secure bit when the execution of the secure code has ended.

The method may include checking, before executing the secure code, whether a flush instruction sequence, that flushes a pipeline and/or an instruction cache, has been executed.

At least one of the above and other features and advantages may be separately realized by providing a computer readable recording medium having recorded thereon a computer executable program code for providing a platform independent secure domain, wherein an execution environment is determined as a secure domain or a non-secure domain by a secure bit, the computer executable program code, including a program for generating a branch instruction by monitoring a call to a secure code by a processor, a program for providing the branch instruction to an instruction bypass ROM, a program for fetching the branch instruction from the instruction bypass ROM and executing the branch instruction, wherein the branch instruction is executed by the processor, and a program for turning on the secure bit when the branch instruction has been successfully executed by the processor.

### BRIEF DESCRIPTION OF THE DRAWINGS

The above and other features and advantages of embodiments will become more apparent to those of ordinary skill in the art by describing in detail exemplary embodiments with reference to the attached drawings, in which:

FIG. 1 illustrates a block diagram of an exemplary embodiment of an execution environment that is divided into a secure domain and non-secure domain;

FIG. 2 illustrates an exemplary embodiment of a block diagram of a secure domain providing apparatus;

FIG. 3 illustrates a schematic diagram of another exemplary embodiment of a secure domain providing apparatus;

FIG. 4 illustrates a schematic diagram of an exemplary embodiment of a conversion of an execution environment of the secure domain providing apparatus of FIGS. 2 and 3 between a secure domain and a non-secure domain;

FIG. 5 illustrates a timing diagram of an exemplary embodiment of an operation of a secure monitor of the secure domain providing apparatus of FIGS. 2 and 3;

FIG. 6 illustrates a flowchart of an exemplary method of providing a secure domain; and

FIG. 7 illustrates a flowchart of an exemplary method of providing a secure domain and converting of an execution environment between a secure domain and a non-secure domain.

### DETAILED DESCRIPTION

Korean Patent Application No. 10-2009-0043095, filed on May 18, 2009, in the Korean Intellectual Property Office, and entitled: “Method and Apparatus for Providing Platform Independent Secure Domain,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element is referred to as being “between” two elements, it can be the only element between the two elements, or one or more intervening elements may also be present. Like reference numerals refer to like elements throughout the specification.

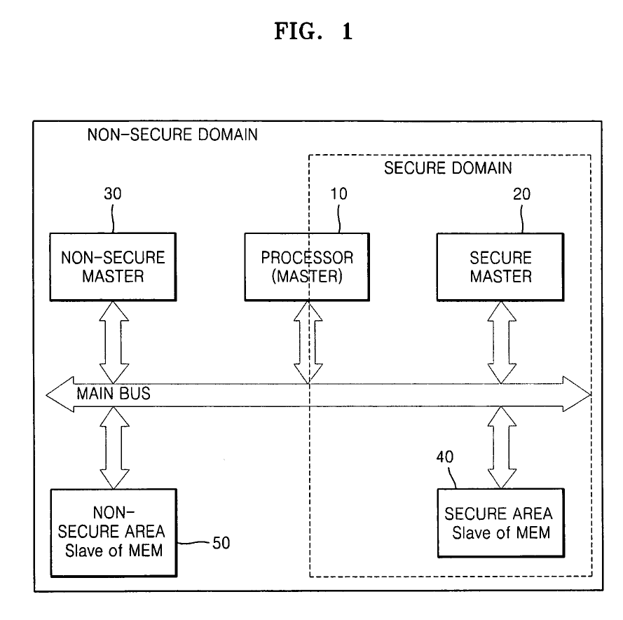

FIG. 1 illustrates a block diagram of an exemplary embodiment of an execution environment that may be divided into a secure domain and a non-secure domain.

Referring to FIG. 1, the execution environment of an application may be divided into a secure domain and a non-secure domain. The secure domain may include a secure master 20 and a secure area slave 40. The non-secure domain may include a non-secure master 30 and a non-secure area slave 50. A processor 10 may communicate with the non-secure domain and the secure domain. A main bus may provide a communication path between the processor 10 and elements of the non-secure domain and the secure domain. More particularly, e.g., the main bus may provide a communication path between the processor 10, the secure master 20, the non-secure master 30, the secure area slave 40, and the non-secure area slave 50.

A general-purpose operating system may not strictly separate applications that handle sensitive security-related data from other applications. Sensitive security-related data may include, e.g., an encryption key, a certificate, an international mobile equipment identity (IMEI), a SIMLock, etc. Sensitive security-related data may be processed at a high security level to help maintain security. However, a general-purpose operating system may not separate applications that handle sensitive security-related data from other applications because processing at higher security levels may, e.g., impede or slow down application performance and/or may be inconvenient for a user. Thus, when employing a general-purpose operating system, it may be hard to guarantee security of the security-related data.

To obtain stability in handling security-related data, an execution environment may be divided into a secure domain and a non-secure domain. Secure code including security-related sensitive data, e.g., a key, a certificate, an IMEI, a SIMLock, etc., and a program for executing the security-related data may be executed in the secure domain. Non-secure code not related to security may be executed in the non-secure domain.

In exemplary embodiments described herein, it may be assumed that an execution environment is separated into a secure domain and a non-secure domain in order to protect security-related data. Embodiments may enable conversion of the execution environment between a non-secure domain and a secure domain using hardware, irrespective of the type of processor and/or the type of operating system. More particularly, e.g., when a call to a secure code is sensed, an execution environment of an application may be converted to a secure domain so that the secure code may be executed in the safe secure domain, e.g., a separate, more secure domain for executing the secure code.

The non-secure domain may correspond to an environment where an application not including security-related data may be executed. Referring to FIG. 1, the processor 10 while not executing a secure code and the non-secure master 30 may not access the secure domain. When the processor 10 is not executing a secure code, the processor 10 may access the non-secure area 50 and may be prohibited from accessing the secure area 40. More particularly, when the processor 10 is not executing a secure code, the processor 10 and the non-secure master 30 may be prohibited from accessing the secure area 40.

The secure domain may correspond to a domain where an application including security-related data may be executed. Referring to FIG. 1, the secure master 20 and the processor 10 while executing a secure code may access both the secure area 40 and the non-secure area 50 via the main bus. The secure master 20 and the processor 10 while executing a secure code may access the secure area 40 and the non-secure area 50 without any limitations.

The secure area 40 and the non-secure area 50 may be slave areas where a physical address may be separated, respectively, according to whether security-related data is contained. The secure area 40 and the non-secure area 50 may include storage devices that may store various data, e.g., a random access memory (RAM), a read only memory (ROM), a flash memory (FM), and an electrically erasable and programmable read only memory (EEPROM), or a magnetic recording device (e.g., HDD).

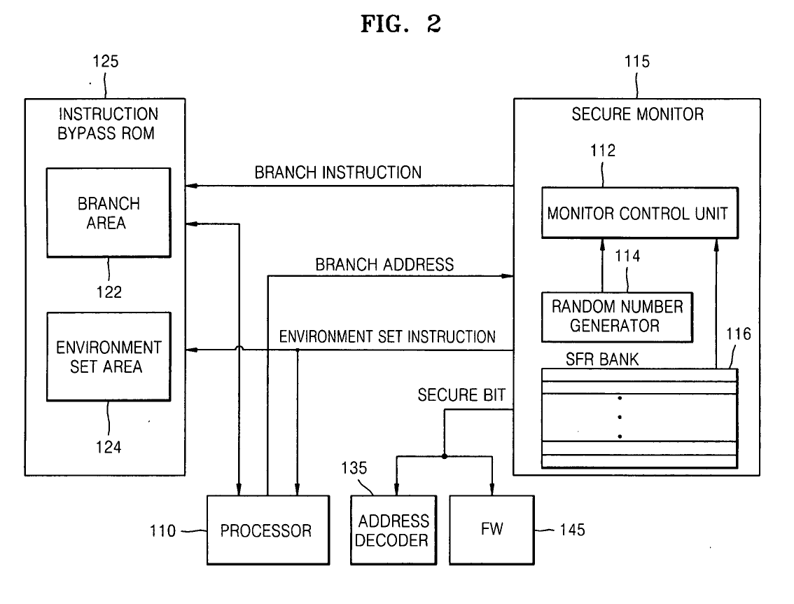

FIG. 2 illustrates an exemplary embodiment of a block diagram of a secure domain providing apparatus.

Referring to FIG. 2, the secure domain providing apparatus may include a processor 110, a secure monitor 115, an instruction bypass ROM 125, an address decoder 135 and an access restrictor 145 (slave fire-wall (FW)).

The secure domain providing apparatus may turn on/off a secure bit SB according to interactive operations of the processor 110, the secure monitor 115, and the instruction bypass ROM 125, and may thereby determine an execution environment to be a secure domain or a non-secure domain.

The processor 110 may include a calculation unit that executes various applications. More particularly, the processor 110 may execute various applications for performing software instructions, executing a secure code including security-related data in the secure domain, executing a non-secure code without security-related data in the non-secure domain, etc.

The secure monitor 115 may monitor the instruction that the processor 110 executes and may turn on/off a secure bit SB to convert an execution environment between a non-secure domain and a secure domain. The secure domain may correspond to an environment where the secure bit SB is turned on, and the non-secure domain may correspond to an environment where the secure bit SB is turned off.

The instruction bypass ROM 125 may be a ROM corresponding to a storage area from which the processor 110 may fetch instructions generated by the secure monitor 115. More particularly, e.g., the instruction bypass ROM 125 may be a hardwired ROM that does not rely on a program. The instructions generated by the secure monitor 115 may be stored in the instruction bypass ROM 125. The processor 110 may fetch instructions stored in the instruction bypass ROM 125 and may execute the fetched instructions.

The secure monitor 115 may generate a branch instruction when the processor 110 calls a secure code and may provide the branch instruction to the instruction bypass ROM 125. The secure monitor 115 may monitor whether the processor 110 fetches the branch instruction and successfully executes it. The secure monitor 115 may turn on a secure bit SB if the branch instruction is successfully executed by the processor 110, and may thereby convert the execution environment to a secure domain. When the execution of the secure code has ended in the secure domain, the secure bit SB may be turned off. Turning off the secure bit may thereby convert the execution environment from the secure domain to the non-secure domain.

Hereinafter, components of the secure domain providing apparatus and functions thereof will be described in detail.

The secure monitor 115 may include a monitor control unit 112, a random number generator 114, and a special function register (SFR) bank 116. The secure monitor may include an address comparator to determine whether a predicted branch address generated by the secure monitor and a next branch address provided by a processor has the same value or not.

The monitor control unit 112 may monitor an operation of the processor 110 and may generate a secure bit SB. The monitor control unit 112 may monitor an operation of the processor 110 and may determine whether the processor 110 has called a secure code.

The random number generator 114 may generate a random branch offset. When a secure code is called by the processor 110, the random number generator 114 may generate a random branch offset and may provide the random branch offset to the monitor control unit 112.

The monitor control unit 112 may use the random branch offset generated by the random number generator 114 and may generate a branch instruction. The monitor control unit 112 may provide the generated branch instruction to the instruction bypass ROM 125.

The instruction bypass ROM 125 may be a hardwired ROM that stores various types of instructions received from the secure monitor 115. The instruction bypass ROM 125 may include a branch area 122 and an environment set area 124. The environment set area 124 may store an environment set instruction. The branch area 122 may be configured to store the branch instruction generated by the monitor control unit 112.

The special function register (SFR) bank 116 may additionally store an environment set instruction regarding the secure domain. The environment set area 124 may be configured to store the environment set instruction of the SFR bank 116.

The branch instruction and/or the environment set instruction, which may be saved in the branch area 122 and the environment set area 124, respectively, may be fetched and performed by the processor 110.

The monitor control unit 112 may monitor whether the branch instruction is successfully executed by the processor 110. If the branch instruction is successfully executed by the processor 110, the monitor control unit 112 may turn on a secure bit SB.

In order to determine whether the branch instruction is or is not successfully executed by the processor 110, the monitor control unit 112 may calculate, in advance, an estimated branch address by using a random branch offset. The monitor control unit 112 may compare a branch address, which may be transferred by the processor 110 while performing the branch instruction, with the estimated branch address calculated in advance by using a random branch offset, and may thereby determine whether the branch instruction was successfully performed by the processor 110.

To further improve, e.g., reinforce, security of the data being processed, in some embodiments, the operation of interactively transmitting and executing the branch instruction may be set to be repeatedly performed a predetermined number of times. In such embodiments, the monitor control unit 112 may turn on a secure bit SB only after the processor 110 has successfully executed a plurality, e.g., the predetermined number, of random branch instructions.

When the secure bit SB is turned on, the execution environment may be converted from the non-secure domain to a secure domain. When the execution environment is in the secure domain, the processor 110 and the secure master 20 may be allowed to access the secure area 40 (FIG. 1), and thereby execute the secure code. When the execution of the called secure code is completed, the monitor control unit may 112 turn off the secure bit SB and convert the execution environment from the secure domain to the non-secure domain.

Meanwhile, while the secure bit SB is being executed, the secure domain may be set with various environment variables based on the environment set instruction. More particularly, the monitor control unit 112 may provide the environment set instruction stored in the SFR bank 116 to the instruction bypass ROM 125 at an initial time, and the instruction bypass ROM 125 may store the received environment set instruction in the environment set area 124. The processor 110 may sequentially fetch an environment set instruction stored in the environment set area 124 of the instruction bypass ROM 125 after the secure bit SB is turned on, may execute the environment set instruction, and may thereby complete a setting operation related to the secure domain.

In some embodiments, the environment set instruction stored in the SFR bank 116 may be configured to be modifiable only when a system including the secure domain providing apparatus is initialized, e.g., when the system is reset or booted up. Thus, the environment set area 124 of the instruction bypass ROM 125 may function as an internal ROM and may change an environment setting when a change of the environment setting is required. That is, e.g., the environment set area 124 may simultaneously function as an internal ROM and to change an environment setting, as required.

Referring to FIGS. 1 and 2, the monitor control unit 112 of the secure monitor 115 may transmit a secure bit to the address decoder 135 and the access restrictor 145, and may thereby prevent the processor 110 or the non-secure master 30 from accessing the secure area 40 in the non-secure domain.

The address decoder 135 may perform address decoding. More particularly, when the secure bit is turned on, the address decoder 135 may perform secure address decoding that may allow address decoding of all address areas, e.g., secure and non-secure areas, and, when the secure bit is turned off, the address decoder 135 may perform non-secure address decoding that may allow address decoding of only a non-secure area.

The access restrictor 145 may be a unit that is used when both a secure area and a non-secure area exist in one slave. The access restrictor 145 may determine whether or not to allow a master or a processor to access a secure area in the slave according to whether the master is a secure/non-secure master 20/30 and the secure bit is turned on/off.

In embodiments, an operating state of the processor 110 may be divided into a non-secure domain state in which a non-secure code may be executed and a secure domain state in which a secure code may be being executed. The non-secure domain state may include a random branch state in which a randomly generated branch instruction may be executed before the non-secure domain state is converted to the secure domain state. The secure domain may have a domain setting state in which a domain required for a secure domain may be set. In order to improve security and/or guarantee safe execution of a secure code, the secure monitor 115 may interactively convert an execution environment by turning on/off a secure bit according to a previously defined branch instruction and whether the environment set instruction has been successfully executed.

In embodiments, for conversion to a safe execution environment, i.e., conversion from a non-secure domain to a secure domain, a code execution flow of the processor 110 may be such that an execution environment is converted to a secure domain that exclusively executes a secure code after execution of a non-secure code is completed in the non-secure domain.

More particularly, e.g., an execution environment may be converted to a secure domain after checking, just before a secure code is executed, whether or not a flush instruction sequence has been executed. A flush instruction sequence may flush a pipeline or an instruction cache including a non-secure code that might remain and be executed. In embodiments, only fetching for executing a flush instruction sequence may be allowed in an attempt to avoid unintentional conversion of the execution environment to a secure domain, which may occur as fetching of the flush instruction sequence is imitated by manipulating the non-secure code, although an actual secure code is not executed.

In embodiments, conversion to a secure domain from an imitation of a branch instruction resulting from a manipulated non-secure code to an artificial secure code may be reduced and/or prevented by employing a randomly generated branch instruction and performing a non-secure code flush function, e.g., at the same time.

In embodiments, the secure monitor 115 and the instruction bypass ROM 125 may be realized separately outside of the processor 110 using hardware, and may be designed transparently from a point of view of the processor 110. Accordingly, embodiments of a secure domain providing apparatus including one or more features described herein may be applied to platforms of all kinds irrespective of the type of processor or type of operating system being used. Embodiments of a secure domain providing apparatus may be designed to be not greatly affected by, e.g., be relatively insensitive to, a timing of an internal bus, and thus may be easily applied to a processor or a bus having a new structure.

By implementing the secure monitor 115 and the hardwired instruction bypass ROM 125 so as to be connected to each other, the security level may be increased far greater than when they are implemented as a software sequence.

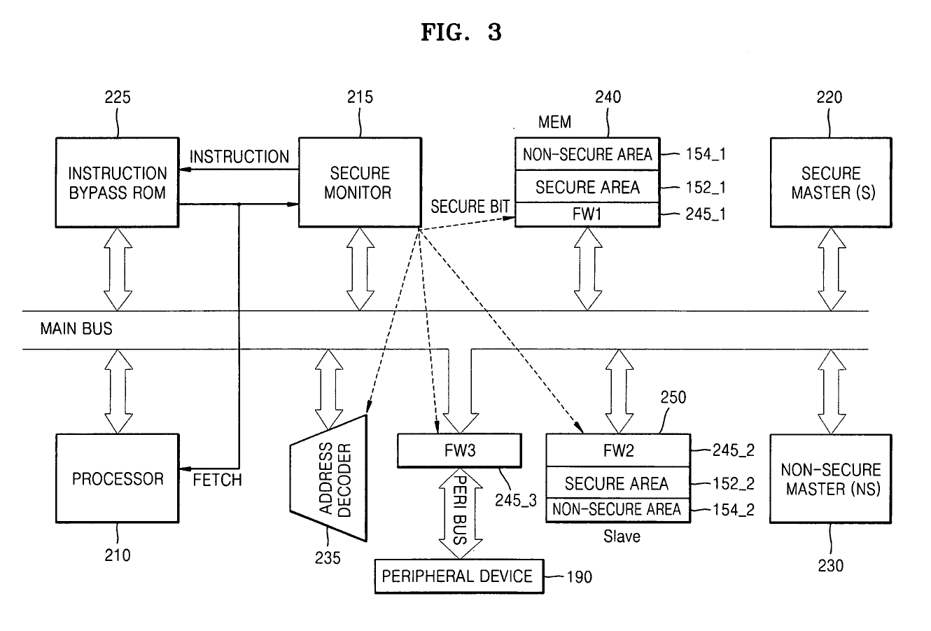

FIG. 3 illustrates a schematic diagram of another exemplary embodiment of a secure domain providing apparatus. Referring to FIG. 3, the secure domain providing apparatus may include a processor 210, a secure monitor 215, an instruction bypass ROM 225, an address decoder 235, and/or access restrictors 245_1, 245_2, 245_3. FIG. 3 also illustrates exemplary slaves 240, 250 and masters, e.g., secure master 220 and non-secure master 230, which may be employed with the secure domain providing apparatus illustrated therein. That is, the exemplary secure domain providing apparatus of FIG. 3 may substantially correspond to the exemplary secure domain providing apparatus of FIG. 2, in a state in which the secure domain providing apparatus is connected with slaves 240, 250 and masters 220, 230. Like reference numerals correspond to like elements of FIGS. 2 and 3.

In embodiments, the slaves 240, 250 may be modules controlled by a processor or a master. The modules may include one or more of various types of storage modules capable of storing data, such as a general hard disk drive (HDD) or a memory, e.g., RAM, ROM, flash memories, etc.

In order to protect security-related data, one or more of the slaves 240, 250 may be divided into secure areas 152_1, 152_2 and non-secure areas 154_1, 154_2, respectively. In embodiments, secure areas and non-secure areas may be realized in separate slaves, respectively, or in one slave. The slaves 240, 250 may include, e.g., one of the access restrictors 245_1, 245_2, respectively.

The access restrictors 245_1, 245_2, 245_3 may be used when a non-secure area and a secure area exist in one slave or in controlling access of a peripheral device 190 connected to the secure area via a peripheral bus. For example, the access restrictors 240_1, 240_2 of the slaves 240, 250 may determine whether a master is a secure/non-secure master 220, 230 and whether the processor 210 may access the secure area based on whether a secure bit is turned on/off. The access restrictors 245_1, 245_2 of a slave may prevent the non-secure master and the processor 210 executing a non-secure code from accessing a secure area.

In embodiments, a master, e.g., the secure master 220, the non-secure master 230, may include and/or be associated with a processor, e.g., 210. The master 220, 230 may include a module that is not controlled by other devices but, e.g., controls one or more of the slaves 240, 250 by itself or exchanges data with the slave. A master may be classified as a secure master 220 and a non-secure master 230. The secure master 220 may access both the above-described secure area and the non-secure area. The non-secure master 230 may access only the non-secure area and may not be allowed to access the secure area. When the processor 210 executes a secure code, it may correspond to the secure master 220, and when the processor 210 executes a non-secure code, it may correspond to the non-secure master 230.

The address decoder 235 may perform secure address decoding or non-secure address decoding according to whether a master requesting an address is the secure master 220 and whether a secure bit is turned on. Secure address decoding may be applied when a master requesting an address is the secure master 220 and/or a secure bit is turned on (including a case where a processor becomes a secure master) and may allow address decoding over all areas. Non-secure address decoding may be applied when a master requesting an address is the non-secure master 230 and/or when a secure bit is turned off (including a case where a processor becomes a non-secure master) and may allow address decoding only in a non-secure area. Thus, if the master requesting an address is the non-secure master 230 or the secure bit is turned off, address decoding with respect to a secure area may be restricted, and the non-secure master 230 may not have access to the secure area.

The secure monitor 215 may be outside the processor 210, or may be mounted in the processor 110, 210. The secure monitor 215 may monitor signals of the processor 210 and signals of a bus. When a special condition under which execution of an authenticated security code existing in a predefined secure area is requested, the secure monitor 215 may turn on/off a secure bit according to whether or not a random branch instruction has been successful according to interactive cooperation between the processor 210 and the instruction bypass ROM 225.

Referring to FIG. 3, the secure bit provided by the secure monitor 215 may be provided to the address decoder 230 and the access restrictors 245_1, 245_2, 245_3, and may thereby prevent a master or a processor from accessing secure areas, e.g., prevent unauthorized access to secure areas.

Embodiments of the secure domain providing apparatus including one or more features described above may be applied to typical general-purpose platforms by directly providing a secure bit generated by the secure monitor 215 to the address decoder 230 and the access restrictors 245_1, 245_2, 245_3.

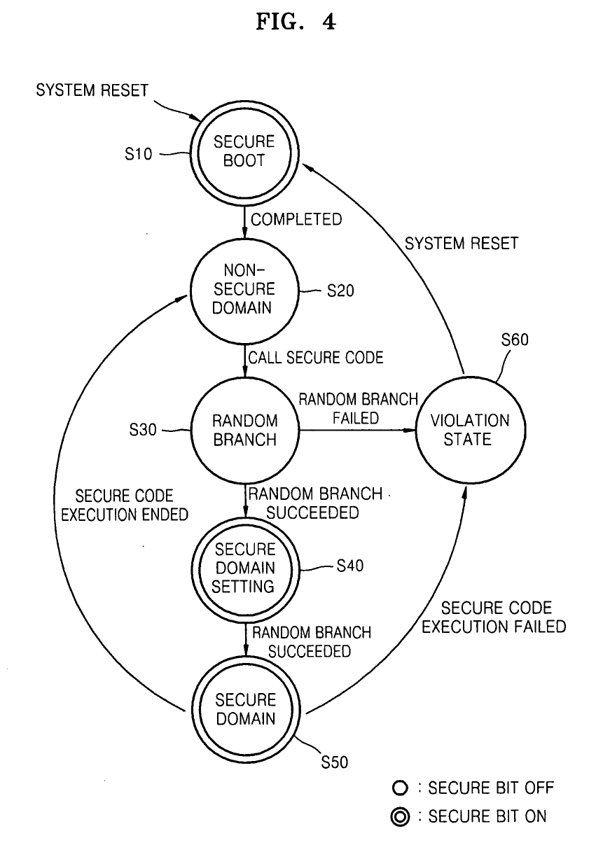

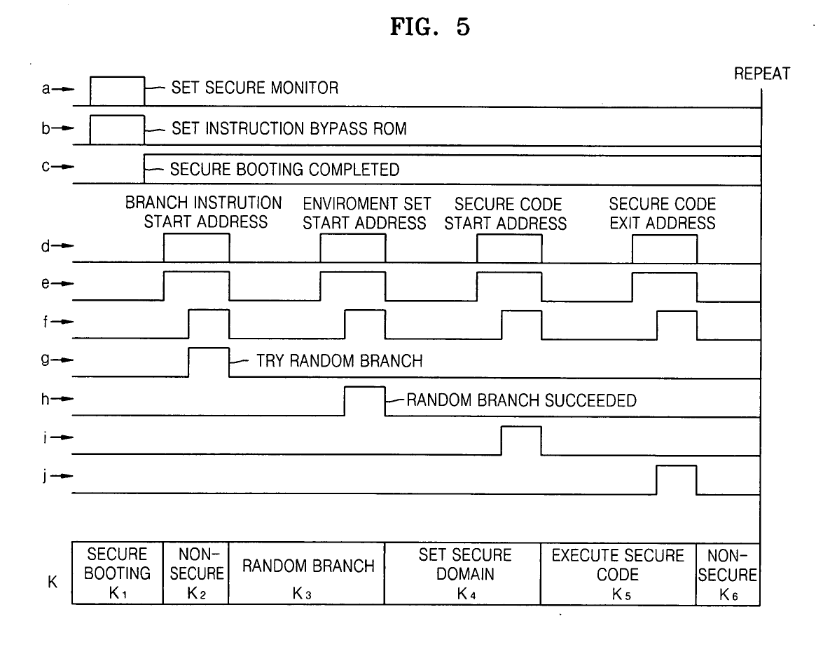

FIG. 4 illustrates a schematic diagram of an exemplary embodiment of a conversion of an execution environment of the secure domain providing apparatus of FIGS. 2 and 3 between a secure domain and a non-secure domain. FIG. 5 illustrates a general timing diagram of an exemplary embodiment of an operation of the secure monitor 115, 215 of the secure domain providing apparatus of FIGS. 2 and 3.

A system including a secure domain providing apparatus, e.g., the secure domain providing apparatus described above with respect to FIGS. 2 and 3, may be initialized in a secure booting environment, and may be converted from a non-secure domain to a secure domain, and then returned to the non-secure domain.

Referring to FIGS. 2, 3 and 4, in a secure boot operation S10, the system including the secure domain providing apparatus may be reset or booted to be initialized. The secure boot operation may be in a secure domain state that may not be affected by the secure monitor 115, 215 until secure booting is completed. In embodiments, an environment set instruction of the SFR bank 116 (FIG. 2) of the secure monitor 115 may be set during the secure boot operation S10. In such embodiments, after the secure boot operation is finished, data stored in the SFR bank 116 of the secure monitor 115 may not be changed.

After the secure boot operation S10 is finished, the execution environment may be converted to a non-secure domain state in operation S20.

When a secure code request for executing a secure code is generated by the processor 110, 210 in the non-secure domain state, a random branch operation S30 may be performed according to interactive operations of the monitor control unit 112 (FIG. 2) and the processor 110, 210.

In the random branch operation S30, the monitor control unit 112 may monitor an operation of the processor 110, 210 to sense a secure code request. When a secure code request is sensed, a branch instruction may be generated one or more times according to a predetermined number, and may be provided to the instruction bypass ROM 125, 225. The monitor control unit 112 may monitor an operation of the processor 110, 210 to determine whether the processor 110, 210 has performed all branch instructions fetched by the processor 110, 210 from the instruction bypass ROM 125, 225.

If the processor 110, 210 fails to execute a random branch operation, the monitor control unit 112 may provide an instruction that branches the system off to a routine related to a violation state, and may thereby set the system so as to be reset in operation S60.

If the processor 110, 210 succeeds in executing a random branch operation, a secure domain setting operation S40 may be started. In the secure domain setting operation S40, the monitor control unit 112 may turn on a secure bit and may provide an environment set instruction stored in the SFR bank 116 to the instruction bypass ROM 125. 225 at the same time. The environment set instruction provided to the instruction bypass ROM 125, 225 may be fetched and executed by the processor 110, 210 such that a setting operation related to a secure domain may be executed.

When the setting of the secure domain is complete, conversion of the execution environment from the non-secure domain to the secure domain may be completed. When the setting of the secure domain is complete, in operation S50, the processor 110, 210 may execute a secure code in the secure domain.

When execution of the secure code is completed, the monitor control unit 112 may turn off a secure bit, and may thereby convert the execution environment from the secure domain to the non-secure domain.

In FIG. 4, circled operations illustrated with a single solid line denote states where a secure bit is turned off, that is, a non-secure domain state, and circled operations illustrated with a double solid line denote states where a secure bit is turned on, that is, a secure domain state. More particularly, the non-secure domain state may include the non-secure code execution operation, operation S20, and the random branch operation S30, and the secure domain state may include the secure boot operation S10, the secure domain setting operation S40, and the secure code execution operation S50.

Referring to FIGS. 4 and 5, embodiments of a secure domain providing apparatus employing one or more features described herein and, more particularly, embodiments of secure monitor thereof employing one or more features described herein, may repeat a plurality of operations, e.g., S10 through S60 and K₁ through K₆, respectively. More particularly, e.g., an initializing and a secure boot operation S10, K₁, a non-secure code execution operation S20, K₂, a random branch operation S30, K₃, a secure domain setting operation S40, K₄, a secure code execution operation S50, K₅, and/or a non-secure code execution operation S60, K₆ may be repeated. One, some or all of the operations may be repeated according to whether or not a secure code is called. Major characteristics of each of the operations will be described below.

Secure boot operation S10, K₁ may correspond to an initialization state. The secure boot operation S10, K₁ may be executed in a secure domain. The processor 110, 210 may access all slaves and memory areas, e.g., secure and non-secure memory areas, during the secure boot operation S10, K₁.

Non-secure code execution operation S20, S60, K₂, K₆ may correspond to a state during which a non-secure code is executed. The processor 110, 210 may access only a non-secure area.

Random branch operation S30, K₃ may correspond to a branch instruction that may be executed when conversion to a secure domain is requested. The random branch operation S30, K₃ may be executed in a non-secure domain state.

Secure domain setting operation S40, K₄ may correspond to execution of a program for setting an execution environment related to conversion to a secure domain. The secure domain setting operation S40, K₄ may be executed in a secure domain state and the processor 110, 210 may access secure and non-secure area, e.g., all, slaves and memory areas.

Secure code execution operation S50, K₅ may correspond to a state during which a secure code may be executed. The secure code execution operation S50, K₅ may be executed in a secure domain state and the processor 110, 210 may access secure and non-secure area, e.g., all, slaves and memory areas.

In the secure boot operation S10, K₁, a system reset and a secure boot may be performed at the same time. While a secure boot is performed, the secure monitor 115, 215 may be controlled and an environment set instruction needed for an environment set area of an instruction bypass ROM 125, 225 may be set by setting an SFR bank 116 of the secure monitor 115, 215. A bit that displays whether a secure boot is completed in a predetermined field of the SFR bank 116 and a bit that displays whether the secure monitor 115, 215 is used may be each set as 1 at a point in time when the secure boot is finished. An operation of the secure monitor 115, 215 may then be started under a secure domain, and a secure bit according to the operation of the secure monitor may be transmitted to the address decoder 135, 235 and the access restrictor 145, 245_1, 245_2 of the slave. When the secure boot is completed, the execution environment may be converted from the secure domain to the non-secure domain.

When a request for execution of a secure code by a processor is generated during the non-secure code execution operation S20, K₂, branching may be conducted with a branch start address of the instruction bypass ROM 125, 225, and the random branch operation S30, K₃ may be started. When a branch instruction is successfully executed by the processor in the random branch operation S30,K₃, branching may be conducted with an environment setting start address, which may thereby start the secure domain setting operation S40, K₄.

In the secure domain setting operation S40, K₄, the secure bit may be turned on, and at the same time, the environment set instruction may be executed by the processor 110, 210, thereby setting a secure domain. When the execution of the environment set instruction is completed, branching may be conducted with an actual secure code start address. When a secure code start address is sensed by the secure monitor, then the secure code execution operation S50, K₅ may be performed.

When the execution of the secure code is completed, branching may be conducted with a secure code exit address. When the secure code exit address is sensed by the secure monitor 115, 215, the non-secure code execution operation S60, K₆ may be performed and the secure bit may be turned off.

Hereinafter, an exemplary method of providing a secure domain using, e.g., an embodiment of a secure domain providing apparatus, e.g., apparatus of FIGS. 2, 3, employing one or more features described above will be described. The exemplary method of providing a secure domain is substantially the same as the operations of the secure domain providing apparatus, and thus, repetitive functions and operations of components of the secure domain providing apparatus will be omitted.

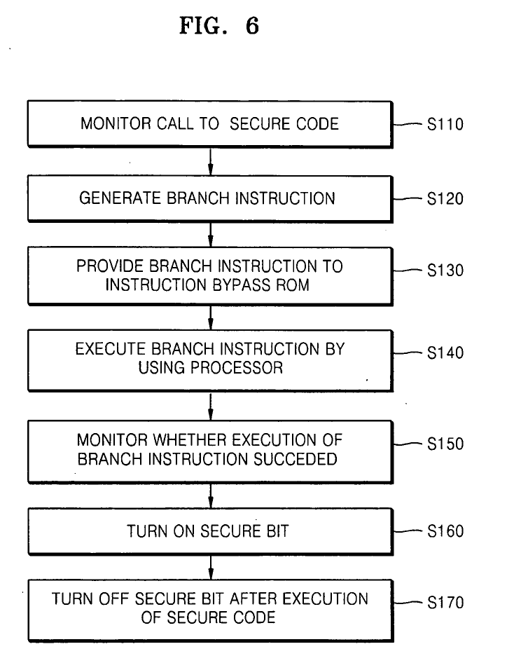

FIG. 6 illustrates a flowchart of an exemplary embodiment of a method of providing a secure domain.

Embodiments may provide a method of providing a secure domain by converting an execution environment between a non-secure domain and a secure domain based on whether a secure bit is turned on/off (a value set by the secure bit). For example, when a request for executing a secure code is sensed in a non-secure domain state, the execution environment may be converted from the non-secure domain to the secure domain by a series of operations that may be realized using hardware so that the secure code may be executed in the safe secure domain.

Referring to FIG. 6, in S110, the secure monitor 115, 215 may sense an operation of the processor 110, 210.

When a call to a secure code by the processor 110, 210 (execution request) is sensed, in S120, a branch instruction may be generated. The branch instruction may be generated using, e.g., a randomly generated branch offset.

In S130, the secure monitor 115, 215 may provide the generated branch instruction to the instruction bypass ROM 125, 225.

In S140, the processor 110, 210 may fetch the branch instruction from the instruction bypass ROM 125, 225 and execute it.

In S150, the secure monitor 115, 215 may sense an operation of the processor 110, 210 and may determine whether execution of the branch instruction by the processor 110, 210 is successful.

In S160, if the secure monitor 115, 215 senses that the branch instruction was successfully executed by the processor 110, 210, the secure monitor 115, 215 may turn on a secure bit to convert the execution environment from a non-secure domain to a secure domain. Whether a branch instruction has been successfully executed or not may be determined by comparing a branch address estimated from a randomly generated branch offset with a branch address that is actually executed by the processor 110, 210.

When the secure bit is turned on, the processor 110, 210 may fetch environment set instructions stored in the environment set area 124 of the instruction bypass ROM 125 and may sequentially execute the environment set instructions to set the secure domain. The instruction bypass ROM 125, 225 may receive an environment set instruction from the secure monitor 115, 215 at the initialization of the system and may store the environment set instruction.

The secure monitor 115, 215 may provide the turned-on secure bit to the address decoder 135, 235 and the access restrictor 145, 245_1 and 245_2, and may thereby restrict unauthorized access to the secure area 152_1 and 152_2.

The secure monitor 115, 215 may also be set to generate a plurality of branch instructions and to turn on a secure bit when the processor 110, 210 has successfully executed the plurality of branch instructions. In such embodiments, the frequency for executing branch instructions may be determined by the setting of a secure domain.

When the secure bit is turned on and the execution environment is converted from the non-secure domain to the secure domain, the processor 110, 210 may execute a secure code. When execution of the secure code is completed, in S170, the secure monitor 115, 215 may turn off a secure bit, and may convert the execution environment from the secure domain to the non-secure domain. The turned-off secure bit may be provided to the address decoder 135, 135 and the access restrictor 145, 245_1, 245_2.

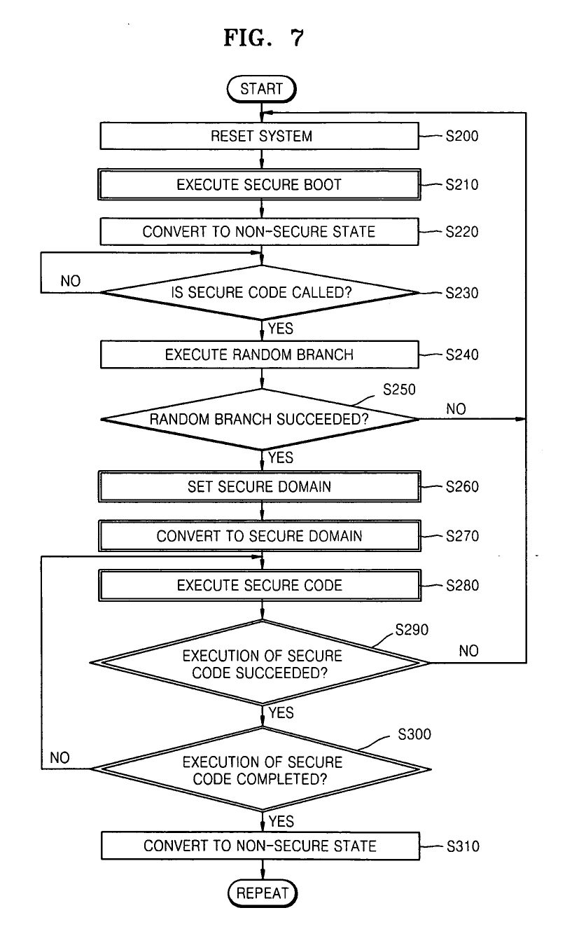

FIG. 7 illustrates a flowchart of an exemplary embodiment of a method of providing a secure domain and converting of an execution environment.

In FIG. 7, circled operations illustrated with a single solid line denote states where a secure bit is turned off, that is, a non-secure domain state, and circled operations illustrated with a double line denote states where a secure bit is turned on, that is, a secure domain state.

Referring to FIG. 7, in S200, a system including, e.g., the secure domain providing apparatus of FIGS. 2, 3, may be reset or booted. In S210, a secure boot operation, which may be an initialization operation, may be performed. During the secure boot operation, an environment set instruction stored in the SFR bank 116 (FIG. 2) in the secure monitor 115 may be provided to the instruction bypass ROM 125. In such embodiments, the environment set instruction stored in the SFR bank 116 may only be changed during the secure boot operation.

After the secure boot operation is performed, in S220, an execution environment of the system may be converted from the secure domain state to the non-secure domain state.

In S230, the secure monitor 115, 215 may monitor whether a secure code is called by the processor 110, 210.

In S240, if a secure code is called, a random branch operation of generating a branch instruction and providing the branch instruction to the instruction bypass ROM 125, 225 may be performed.

In S250, the secure monitor 115, 215 may determine whether the random branch operation performed by the processor 110, 210 by fetching a branch instruction has been successfully executed. If the random branch operation is successful, in S260, the secure monitor 115, 215 may turn on a secure bit, and the processor 110, 210 may perform a secure domain setting operation, including fetching an environment set instruction from the instruction bypass ROM 125, 225 and executing the environment set instruction. Otherwise, if the random branch operation fails, a problem may have occurred in converting the execution environment to a secure domain, and thus the whole system may be reset.

In S270, when the secure bit is turned on and the secure domain setting is completed, the execution environment may be converted from the non-secure domain to the secure domain.

In S280, when the execution environment is converted to the secure domain state, the processor 110, 210 may execute a secure code.

In S290, it is determined whether execution of the secure code is successful.

If, in S290, it was determined that execution of the secure code was successful, in S300, the execution of the secure code is ended.

In S300, the secure monitor 115, 215 may turn off a secure bit and convert the execution environment from the secure domain to the non-secure domain. The above-described operations may then be repeated.

If, in S290, it was determined that execution of the secure code failed, the system may go back to S200 and be reset. In such cases, the secure monitor 115, 215 may monitor whether a secure code is called by the processor 110, 210, and repeat the above-described operations.

Embodiments may be embodied as computer readable code on a computer readable recording medium. Computer readable recording medium may be any data storage device that may store data that may be thereafter read by a computer system: Examples of the computer readable recording medium include read-only memory (ROM), random-access memory (RAM), CD-ROMs, magnetic tapes, floppy disks, optical data storage devices, etc. (such as data transmission through the Internet). The computer readable recording medium may also be distributed over network coupled computer systems so that the computer readable code may be stored and executed in a distributed fashion.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A platform independent secure domain providing apparatus, which determines whether an execution environment is to be in a secure domain and a non-secure domain by a secure bit, the apparatus comprising:
a secure monitor that is adapted to generate a branch instruction when a call to a secure code is sensed, turn on the secure bit when the branch instruction has been successfully executed, and turn off the secure bit when the execution of the secure code is finished;
an instruction bypass read only memory (ROM) adapted to receive the branch instruction from the secure monitor; and
a processor adapted to execute the branch instruction that is fetched from the instruction bypass ROM.

2. The apparatus as claimed in claim 1, wherein the secure monitor comprises:
a random number generator adapted to randomly generating a branch offset; and
a monitor control unit adapted to generate the branch instruction by using the generated branch offset when the call to the secure code is sensed.

3. The apparatus as claimed in claim 2, wherein the secure monitor is adapted to generate the branch instruction a predetermined number of times, and to turn on the secure bit when the processor has successfully fetched all of the generated branch instructions.

4. The apparatus as claimed in claim 1, wherein the secure monitor comprises a special function register (SFR) bank that is adapted to store an execution set instruction for setting the secure domain, wherein the execution set instruction is provided to the instruction bypass ROM from the SFR bank, and is sequentially fetched by the processor after the secure bit is turned on.

5. The apparatus as claimed in claim 1, wherein the secure monitor provides the secure bit to an address decoder and/or an access restrictor, and the address decoder or the access restrictor is adapted to control access of the processor to a secure area related to the secure code, based on the secure bit.

6. The apparatus as claimed in claim 1, wherein when the secure bit is turned off, the execution environment is converted from the secure domain to the non-secure domain, and when the secure bit is turned on, the execution environment is converted from the non-secure domain to the secure domain.

7. The apparatus as claimed in claim 1, wherein the secure monitor is arranged away from the processor.

8. The apparatus as claimed in claim 1, wherein the secure monitor is mounted on the processor.

9. The apparatus as claimed in claim 1, wherein the instruction bypass ROM is arranged away from the processor.

10. The apparatus as claimed in claim 1, wherein the instruction bypass ROM is mounted on the processor.

11. The apparatus as claimed in claim 1, wherein the instruction bypass ROM is a hardwired ROM.

12. The apparatus as claimed in claim 1, wherein the instruction bypass ROM and the secure monitor are connected to each other.

13. A method of providing a platform independent secure domain, wherein an execution environment is determined as a secure domain or a non-secure domain by a secure bit, the method comprising:
generating a branch instruction by monitoring a call to a secure code by a processor;
providing the branch instruction to an instruction bypass ROM;
fetching the branch instruction from the instruction bypass ROM and executing the branch instruction, wherein the branch instruction is executed by the processor; and
turning on the secure bit when the branch instruction has been successfully executed by the processor.

14. The method as claimed in claim 13, further comprising providing the secure bit to an address decoder and/or an access restrictor,
wherein the address decoder and/or the access restrictor control access of the processor to a secure area related to the secure code, based on the secure bit.

15. The method as claimed in claim 13, further comprising:
fetching an execution set instruction from the instruction bypass ROM after the secure bit is turned on, wherein the fetching of the execution setup instruction is performed by the processor; and
setting the execution environment as a secure domain, wherein the setting of the execution environment is performed by the processor.

16. The method as claimed in claim 13, wherein the branch instruction is generated a predetermined number of times, and if all of the generated branch instructions are executed successfully by the processor, the secure bit is generated.

17. The method as claimed in claim 16, wherein it is determined if all the generated branch instructions are executed successfully by calculating, in advance, an estimated branch address using a random branch offset, and comparing a branch address transferred by the processor while performing the branch instruction with the estimated branch instruction.

18. The method as claimed in claim 13, further comprising:
executing the secure code after the secure bit is turned on, wherein the secure code is executed by the processor; and
turning off the secure bit when the execution of the secure code has ended.

19. The method as claimed in claim 18, further comprising:
checking, before executing the secure code, whether a flush instruction sequence, that flushes a pipeline and/or an instruction cache, has been executed.

20. A computer readable recording medium having recorded thereon a computer executable program code for providing a platform independent secure domain, wherein an execution environment is determined as a secure domain or a non-secure domain by a secure bit, the computer executable program code, comprising:
a program for generating a branch instruction by monitoring a call to a secure code by a processor;
a program for providing the branch instruction to an instruction bypass ROM;
a program for fetching the branch instruction from the instruction bypass ROM and executing the branch instruction, wherein the branch instruction is executed by the processor; and
a program for turning on the secure bit when the branch instruction has been successfully executed by the processor.
